(19) United States
(12) Patent Application Publication
(10) Pub. No.: US 2012/0019668 A1
(43) Pub. Date: Jan. 26, 2012

(54) VIDEO SPECIFIC BUILT-IN SELF TEST AND SYSTEM TEST FOR CROSSPOINT SWITCHES

(75) Inventors: Nigel Seth-Smith, Lymington (GB); John Hudson, Burlington (CA)

(73) Assignee: GENNUM CORPORATION, BURLINGTON (CA)

(21) Appl. No.: 13/138,231

(22) PCT Filed: Jan. 21, 2010
(86) PCT No.: PCT/CA2010/000054

§ 371 Date: Oct. 3, 2011

Related U.S. Application Data
(60) Provisional application No. 61/146,114, filed on Jan. 21, 2009.

(51) Int. Cl. H04N 17/00

(52) U.S. Cl. 348/181; 348/E17.001

(57) ABSTRACT

A crosspoint selector switch and test module, comprising: a crosspoint switch having a plurality of inputs and a plurality of outputs, wherein the outputs can be selectively switched to respective inputs; and a test system co-packaged with the crosspoint switch, the test system comprising a test signal generator that can be selectively connected to provide signals to the inputs of the crosspoint switch and a test signal analyzer that can be selectively connected to receive signals from the outputs of the crosspoint switch, wherein the test signal generator is configured to produce video data test signals that conform to a known format, and the signal analyzer is configured to analyze video data test signals that conform to the known format.

This application claims the benefit of and priority to U.S. Patent Application No. 61/146,114 filed Jan. 21, 2009, the contents of which are incorporated herein by reference.

### BACKGROUND

Embodiments described herein relate to crosspoint selector switches having test circuitry.

Crosspoint selector switches are used in video switching or routing. Semiconductor implemented crosspoint selector switches interconnect equipment through a configurable crosspoint switch matrix. The heart of a video switcher or router is typically a crosspoint switch. Built-in-tests can be built into crosspoint switches, particularly large ones with many inputs and outputs. This built-in-test typically takes the form of a pseudo random bit stream (PRBS) generator which can be selected as one of the inputs to the crosspoint switch, and a PRBS analyzer which can be selected as one of the outputs from the crosspoint switch. In this way the PRBS generator can be used as a feed to any of the equipment that has a signal feed from the crosspoint switch, and the analyzer can test the signal from any of the equipment feeding the crosspoint switch inputs.

### SUMMARY

According to one example embodiment is a crosspoint selector switch and test module, comprising: a crosspoint switch having a plurality of inputs and a plurality of outputs, wherein the outputs can be selectively switched to respective inputs; and a test system comprising a test signal generator that can be selectively connected to provide signals to the inputs of the crosspoint switch and a test signal analyzer that can be selectively connected to receive signals from the outputs of the crosspoint switch, wherein the test signal generator is configured to produce video data test signals that conform to a known format, and the signal analyzer is configured to analyze video data test signals that conform to the known format.

According to another example embodiment is a crosspoint selector switch and test module comprising a crosspoint switch having a plurality of outputs that can be selectively switched to inputs thereof, and a built-in a test system comprising a test signal generator that can be selectively connected to provide signals to the inputs of the crosspoint switch and a test signal analyzer that can be selectively connected to receive signals from the outputs of the crosspoint switch, wherein the test signal generator is configured to produce video data test signals that conform to a known format, and the signal analyzer is configured to analyze video data test signals that conform to the known format.

### BRIEF DESCRIPTION OF THE DRAWINGS

FIG. 1 is a block diagram representation of a crosspoint selector switch having a test system applied thereto according to an example embodiment of the invention.

FIG. 2 is a block diagram representation of the crosspoint selector switch of FIG. 1 in a system test configuration according to an example embodiment of the invention.

The same reference numerals may be used throughout the Figures to denote items having the same or similar functions.

### DESCRIPTION

As noted above, built-in-tests can be built into crosspoint switches, particularly large ones with many inputs and outputs, and these built-in-test typically takes the form of a pseudo random bit stream (PRBS) generator which can be selected as one of the inputs to the crosspoint switch, and a PRBS analyzer which can be selected as one of the outputs from the crosspoint switch.

For digital video signals conforming to the serial digital interface (SDI) standards used in the video industry and documented by the society of motion picture and television engineers (SMPTE), a PRBS will not be recognised as a valid signal by equipment. A more useful test signal is one that does conform to SMPTE standards. Similarly, a more useful analyzer is one that recognises a SMPTE SDI signal and can extract and analyze its contents. For example, the SMPTE SDI signal itself contains cyclic redundancy check (CRC) codes for the purpose of error detection and correction. An analyzer with the ability to use these codes could collect a direct reading of the error count of each of the crosspoint switch input signals and feed it via a control and monitoring interface on the crosspoint to the controlling application for the switcher or router.

Similarly, a test signal generator with a SMPTE compliant output could be used to test any of the equipment whose input(s) are connected to the outputs of the crosspoint switch.

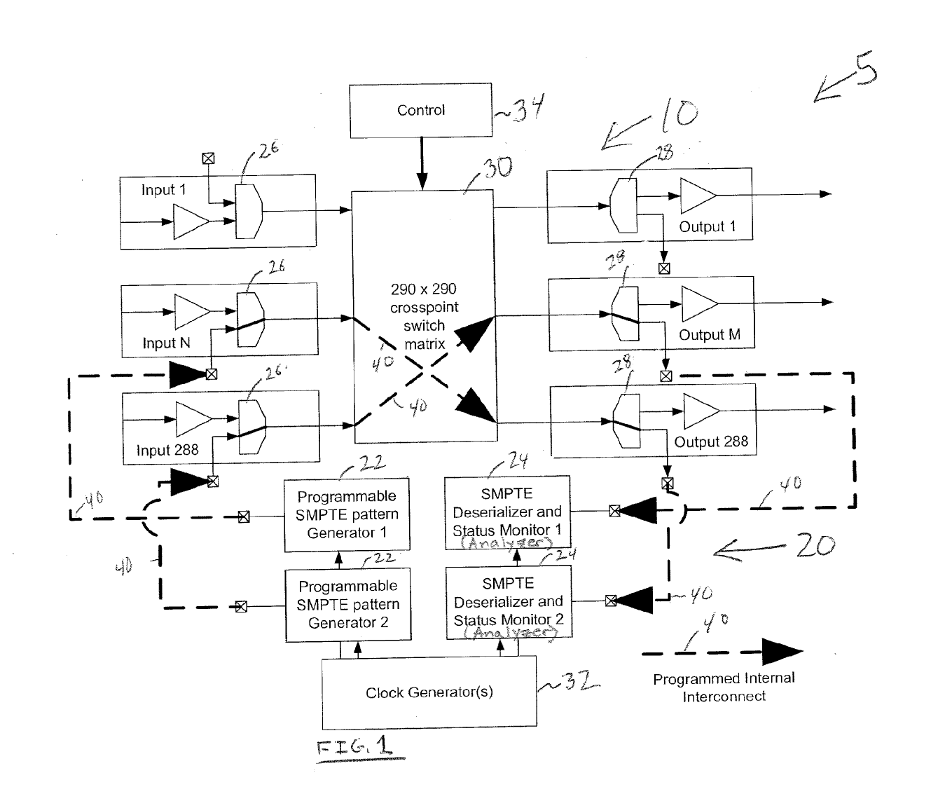

Accordingly, in at least one example embodiment of this invention, one or more SMPTE SDI compliant test signal generators and analyzers are built-in with a crosspoint switch. By way of non exhaustive example, such generators and analyzers could generate and analyze test signal formats that are compatible with one or more of the following: SMPTE 352M, SMPTE 425M (Level A and/or Level B), SMPTE 424M, SMPTE 292M, SMPTE 259M-C and DVB-ASI. In this regard, FIG. 1 illustrates, according to an example embodiment, a block diagram representation of a crosspoint selector switch and built-in test module 5 with self test functionality that includes a crosspoint switch 10 combined with a built-in test system 20. In an example embodiment, the crosspoint switch 10 includes a configurable crosspoint switch matrix 30 that operates under control of a control circuit 34 to selectively internally connect outputs of the switch matrix 30 to respective inputs of the switch matrix 30. In the embodiment shown in FIG. 1, the crosspoint switch matrix 30 comprises a 290×290 switch matrix, however the switch matrix could have more than or fewer than 290 inputs and outputs, and could have a different number of inputs than outputs.

The test system 20 includes one or more SMPTE SDI compliant test signal generators 22 that can be selectively connected to respective inputs of the crosspoint switch matrix 30 of crosspoint switch 10, and one or more SMPTE SDI compliant test signal analyzers 24 that can be selectively connected to respective outputs of the crosspoint switch matrix 30 of crosspoint switch 10. In an example embodiment, the internal interconnects used to selectively connect the switch matrix inputs (Input 1 to Input 290) and outputs (Output 1 to Output 290) as well as the interconnects 40 used to selectively connect test signal generators 22 to the switch matrix inputs and the test signal analyzers 24 to the switch matrix outputs are programmed internal interconnects that are implemented under configuration data provided by the control circuit 34. Examples of programmed internal interconnects in one possible programmed configuration of combined crosspoint switch and self test module 5 are represented by dashed lines 40 in FIG. 1. In example embodiments, the test system 20 includes one or more clock generators 32 for providing reference timing signals to the generators and analysers 22, 24.

In one example embodiment, the generator 22 can be implemented using a full SMPTE compliant SDI serializer, such as the GS2972 manufactured by Gennum Corporation and the analyzer 24 can be implemented using a full SMPTE compliant SDI deserializer, such as the GS2970 manufactured by Gennum Corporation.

In one example embodiment, the generator 22 could be simplified to a bit stream generator which emulates a SMPTE SDI serializer with a particular test signal or choice of test signals at its input.

In another embodiment the analyzer 24 would have limited functionality, for example analyzing the timing data, line count data, video format information, error checking data, ancillary data, audio data, or a subset of the above, in the SDI data stream. Other examples of partial signal stream analysis can be appreciated.

In some example embodiments, the generator and analyzer can also be used as PRBS generators and analyzers. For example, a generator 22 could be configured to generate a PRBS signal in addition to an SMPTE SDI compliant signal and an analyzer 24 configured to analyze a PBRS signal in addition to an SMPTE SDI compliant signal.

As suggested by the term “built-in”, in example embodiments the test system 20 and the crosspoint switch 10 of the combined crosspoint selector switch and built-in test module 5 are combined into a single unit or module. In this regard, in some example embodiments, the test system 20, including generator 22 and analyzer 24, is implemented using silicon chips (for example the above mentioned GS2972 and GS2970 manufactured by Gennum Corporation) that are co-packaged with the silicon carrying the other circuitry of crosspoint switch 10—for example, the test system 20 is implemented as one or more integrated circuits in silicon chips secured to a common substrate such as a common printed circuit board with a silicon chip carrying an integrated circuit implementing the crosspoint switch 10. In other example embodiments of a single module, the test system 20, including generator 22 and analyzer 24 are implemented as functional integrated circuits on the same silicon that carries the other circuitry of crosspoint switch 10—for example the test system 20 and crosspoint switch 10 are all integrated on a monolithic silicon chip. In some example embodiments, CMOS technology is used to implement the combined crosspoint switch and test module 5.

In the illustrated embodiment, each input to the crosspoint switch matrix 30 of switch 10 includes a selector switch 26 that allows a test signal from the generator(s) 22 to be selectively provided to any input of the crosspoint switch matrix 30. Similarly, each output from the crosspoint switch matrix 30 includes a selector switch 28 that allows the output to be selectively provided to an analyzer 24. Having its own dedicated test system 20 that includes generator 22 and analyzer 24 allows the crosspoint switch 10 to perform self testing by feeding a test signal from the generator 22 through any input/output combination of the crosspoint switch matrix for analysis at the analyzer 24.

The programmed internal interconnect lines 40 shown in FIG. 1 illustrate one possible self test configuration for combined crosspoint switch and self test module 5. In the example of FIG. 1, the two generators 22 (labelled as Programmable SMPTE pattern Generator 1 and Programmable SMPTE pattern Generator 2) and two analyzers 24 (labelled as SMPTE Deserializer and Status Monitor 1 and SMPTE Deserializer and Status Monitor 2) are used simultaneously to either accelerate testing or potentially allow testing of two different formats (for example standard definition and 3G), or both. In FIG. 1, Programmable SMPTE pattern Generator 1 is switched to Input N of the switch matrix 30, which is switched within the switch matrix 30 to Output 288. Output 288 is monitored by one of the analyzers 24 (SMPTE Deserializer and Status Monitor 2) to complete the test loop. Similarly, Programmable SMPTE pattern Generator 2 is switched to Input 288 of the switch matrix 30, which is switched within the switch matrix 30 to Output M. Output M is monitored by the other analyzer 24 (SMPTE Deserializer and Status Monitor 1) to complete the test loop. By selecting different configuration paths within the switch matrix 206 and switching the generators 22 and the analyzers 24 to different inputs and outputs corresponding to the paths configured in the switch matrix 206 the entire crosspoint switch matrix 30 architecture can be tested to SMPTE standards. As indicated above, two or more generator-analyzer pairs can be used simultaneously to accelerate testing which each generator-analyzer pair testing an assigned subset of possible switch configurations, or to apply different test formats to the switch matrix 206.

A crosspoint switch 10 having a test system 20 that includes generator 22 and analyzer 24 can also be used to perform system testing. In some example embodiments, the generator 22 can be used to generate test signals that are outputted from the cross-point switch 10 and then routed to downstream equipment and then provided back to the crosspoint switch at inputs that are then routed to analyzer 24. In some example embodiment, the generator 22 can be used to generate signals that are outputted from the cross-point switch 10 and then routed to downstream equipment and then provided as inputs to a different downstream crosspoint switch and routed to analyzer 24 of that downstream crosspoint switch for analysis. Alternatively, the signals generated at a generator 22 and outputted from the cross-point switch 10 could be provided to an external industry standard analyzer that is not associated with a particular cross-point switch. Similarly, the signals that are being analyzed at an analyzer 24 that is associated with a particular crosspoint switch 10 could originate at an external industry standard generator that is not associated with a particular crosspoint switch.

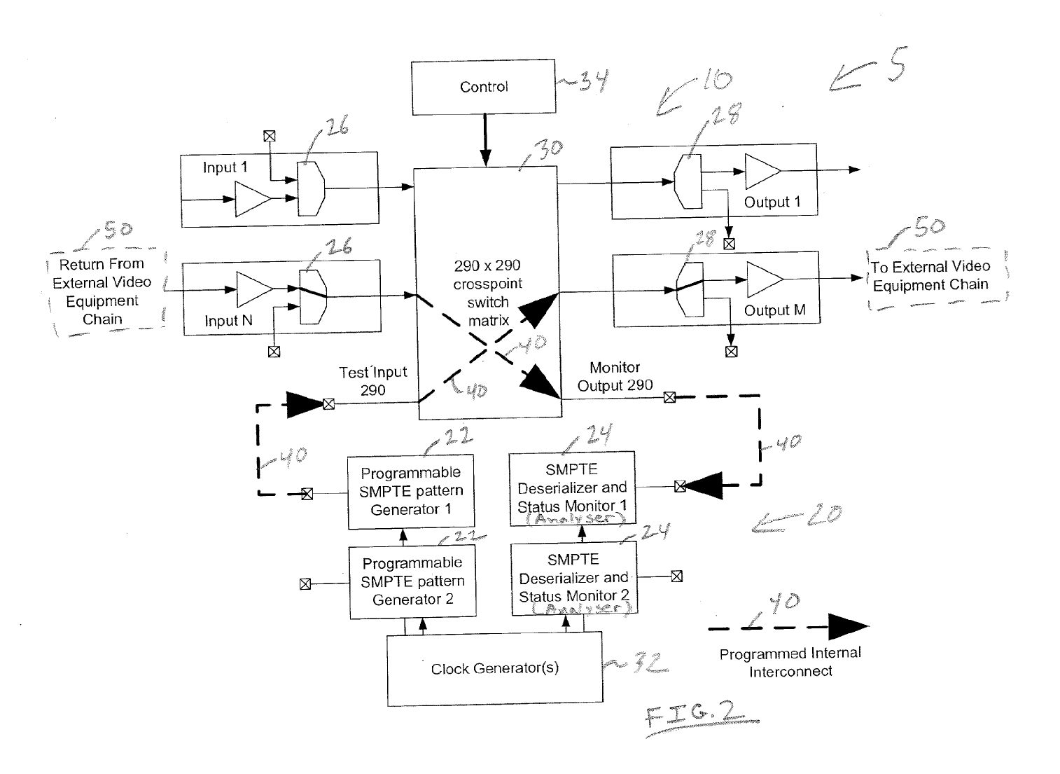

FIG. 2 illustrates, according to example embodiments of the invention, the crosspoint selector switch module 5 being used to test external video equipment 50 using one pair of the built in SMPTE test generators 22 and analyzers 24. In the example of FIG. 2 only one test generator 22 and analyzer 24 is used, but it can appreciated that a duplicate set up can be operated simultaneously using the other generator 22 and analyzer 24, either for the data format or a different data format. In the example the test signal generator 22 (Programmable SMPTE pattern Generator 1) feeds a dedicated test input (Test Input 290) of the crosspoint switch matrix 30. Test Input 290 is switched by the crosspoint switch matrix 30 to Output M, which is connected to an external piece of equipment 50, or equipment chain. The output of this external equipment or equipment chain 50 is fed into crosspoint switch matrix Input N and switched by the switch matrix to a dedicated test output (Test Output 290) of the crosspoint switch matrix 30, and thence to the SMPTE analyzer 24 (SMPTE Deserializer and Status Monitor 1). As one function of a crosspoint switch is to interconnect equipment in a production facility, it is very probable that once operationally installed the crosspoint selector switch module 5 will be directly connected to much of the equipment in the facility. This means that the crosspoint switch module 5 is a convenient location for system testing, as it is already connected to the equipment that needs to be tested. The switch matrix 30 can be provided with additional dedicated test inputs and outputs for connecting additional test signal generators and test signal analyzers to external equipment.

PRBS and SMPTE test signals can have different spectral characteristics, and the self-testing and system testing abilities of the crosspoint switch 10 in at least some example embodiments facilitates testing of the crosspoint core matrix itself as well as external equipment using SMPTE signals and PRBS signals. In some example embodiments, video data in a known video data format other than SMPTE compliant data could be used.

Accordingly, in at least some example embodiments, the test system 20 can be used to implement a built in self test and system with features such as a programmable PRBS pattern generator and analyzer that may be applied to any input or output of the crosspoint switch as appropriate. The system 20 can also feature built in SMPTE test pattern generators for standard definition and high definition video applications (including 1080p50/60). The pattern generators may be individually applied to any input of the crosspoint switch without impacting the normal operation of any other channel. A broadcast all feature can also be included. Thus, in various example embodiments, one or more of the following may be provided: built in system test features with on chip PRBS Tx and Rx generators; built in SMPTE pattern generators including colour bars, and pathological signal generators; signal status monitoring covering multiple channels, and including: Video standard/format identification; EDH (Error Detection and Handling) packet detection; CRC (Cyclic Redundancy Check) calculation and error indication; Audio channel status and error monitoring; TRS (Timing Reference Signal) error detection; ANC (Ancillary) data CSUM (Check Sum) error detection; HD (High Definition) Line based CRC error detection; SMPTE 352M packet detection and extraction; and Programmable ANC data extraction.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A crosspoint selector switch and test module, comprising:
a crosspoint switch having a plurality of inputs and a plurality of outputs, wherein the outputs can be selectively switched to respective inputs; and
a test system comprising a test signal generator that can be selectively connected to provide signals to the inputs of the crosspoint switch and a test signal analyzer that can be selectively connected to receive signals from the outputs of the crosspoint switch, wherein the test signal generator is configured to produce video data test signals that conform to a known format, and the signal analyzer is configured to analyze video data test signals that conform to the known format.

2. A crosspoint selector switch and test module comprising a crosspoint switch having a plurality of outputs that can be selectively switched to inputs thereof, and a built-in a test system comprising a test signal generator that can be selectively connected to provide signals to the inputs of the crosspoint switch and a test signal analyzer that can be selectively connected to receive signals from the outputs of the crosspoint switch, wherein the test signal generator is configured to produce video data test signals that conform to a known format, and the signal analyzer is configured to analyze video data test signals that conform to the known format.

3. The crosspoint selector switch and test module of claim 1 wherein the test signal generator is configured to produce video data test signals that are compliant with one or more SMPTE standards, and the signal analyzer is configured to analyze video data test signals that conform to the one or more SMPTE standards.

4. The crosspoint selector switch and test module of claim 1 wherein the test signal generator is configured to produce video data test signals that are compliant with one or more SMPTE SDI standards, and the signal analyzer is configured to analyze video data test signals that conform to the one or more SMPTE SDI standards.

5. The crosspoint selector switch and test module of claim 1 wherein the video data test signals produced by the test signal generator includes signals for a video image test pattern.

6. The crosspoint selector switch and test module of claim 5 wherein the signal analyzer is configured to perform CRC (Cyclic Redundancy Check) calculations in respect of signals received thereby.

7. The crosspoint selector switch and test module of claim 6 wherein the test signal generator is configured to also produce PRBS test signals, and the signal analyzer is configured to also analyze PRBS test signals.

8. The crosspoint selector switch and test module of claim 7 wherein the test system and the crosspoint switch are formed as integrated circuits on a monolithic silicon chip.

9. The crosspoint selector switch and test module of claim 7 wherein the test system and the crosspoint switch are co-packaged as silicon chips that are carried on a common substrate.

10. The crosspoint selector switch and test module of claim 9 wherein the crosspoint switch includes a crosspoint switch matrix having the plurality of inputs and plurality of outputs, the inputs each having a selector switch that allows the test signal from the test signal generator to be selectively provided thereto, and each output from the crosspoint switch matrix includes a selector switch that allows the output to be selectively provided to the signal analyzer.

11. The crosspoint selector switch and test module of claim 10 wherein the crosspoint switch includes at least one dedicated test signal input for receiving video data test signals from the signal generator for routing to an output of the crosspoint switch connected to external equipment, and at least one dedicated test signal output for receiving video data test signals back from the external equipment through the crosspoint switch.

12. The crosspoint selector switch and test module of claim 11 wherein the test system comprises multiple test signal generators and multiple test signal analyzers enabling simultaneous testing of multiple portions of the crosspoint switch.

13. A method of testing a crosspoint selector switch comprising:
providing a crosspoint selector switch and test module;
selectively applying video data test signals from the test signal generator to respective inputs of the crosspoint switch; and
receiving at the signal analyzer signals from outputs of the crosspoint switch when those outputs are each connected to the respective inputs as the video data test signals are applied thereto.

14. A method of testing external equipment using a crosspoint selector switch having a test system, comprising:
providing a crosspoint selector switch and test module;
applying video data test signals from the test signal generator to an input of the crosspoint switch that is switched to provide the signals to the external equipment; and
receiving at the signal analyzer through the crosspoint switch signals from the external equipment corresponding to the video data test signals.
